(19) United States
(12) Patent Application Publication
(10) Pub. No.: US 2024/0054268 A1
(43) Pub. Date: Feb. 15, 2024

(54) METHODS AND SYSTEMS FOR PHYSICS-BASED REDUCED-ORDER MODELING OF LOCAL DYNAMICS IN ADDITIVE MANUFACTURING

(71) Applicant: Palo Alto Research Center Incorporated, Palo Alto, CA (US)

(72) Inventor: Morad BEHANDISH, San Mateo, CA (US)

(73) Assignee: Palo Alto Research Center Incorporated, Palo Alto, CA (US)

(21) Appl. No.: 17/819,488

(22) Filed: Aug. 12, 2022

(51) Int. Cl. G06F 30/27; G06F 30/23; B22F 10/85; B33Y 50/02

(52) U.S. Cl. CPC G06F 30/27; G06F 30/23; B22F 10/85; B33Y 50/02; B22F 10/22

(57) ABSTRACT

A method systematically developing reduced-order (e.g., upscaled or coarse-grained, lumped- or distributed-parameter) multi-physics models for simulating additive manufacturing may include: describing governing equations of an additive manufacturing process; refactoring the governing equations into (1) constitutive laws with unknown coefficients and (2) conservation laws; discretizing the governing equations; and training the unknown coefficients of the constitutive laws with simulated data and/or experimental data relating to the additive manufacturing process where the conservation laws are enforced in the training regardless of a granularity of the constitutive laws, thereby yielding a reduced-order set of governing equations.

### FIELD OF INVENTION

The present disclosure relates to methods and systems for reduced-order modeling and simulation of local dynamics in additive manufacturing processes.

### BACKGROUND

One of the main challenges in developing and fine-tuning novel additive manufacturing processes is to predict as-printed shape and material properties from process parameters. The ability to make such predictions accurately and rapidly is paramount to solving inverse problems such as designing the components and closed-loop control of the 3D printer as well as design, redesign, and process planning of parts to make them 3D printable. Unfortunately, such predictions often require high-fidelity computational fluid/solid dynamics simulations at a much smaller scale than part dimensions (e.g., droplet-scale simulations for liquid metal jetting, melting pool simulations for selective laser melting, and the like). Therefore, to model a complete part, the smaller scale simulations need to be done iteratively (e.g., for millions of droplets per part, for a moving and evolving melting pool, and the like). Given that each smaller scale simulation can take a few minutes to several hours, depending on the resolution and compute power, iteratively repeating the smaller scale simulation to make predictions at the part-scale is computationally prohibitive and does not scale to end-user applications.

### SUMMARY OF INVENTION

The present disclosure relates to systematically developing reduced-order (e.g., upscaled or coarse-grained, lumped- or distributed-parameter) multi-physics models for simulating additive manufacturing. The present disclosure further relates to methods and systems that utilize the said models.

For example, a method comprising: describing governing equations of an additive manufacturing process; refactoring the governing equations into (1) constitutive laws with unknown coefficients and (2) conservation laws; discretizing the governing equations; and training the unknown coefficients of the constitutive laws with simulated data and/or experimental data relating to the additive manufacturing process where the conservation laws are enforced in the training regardless of a granularity of the constitutive laws, thereby yielding a reduced-order set of governing equations.

In another example, a system may comprise: a computing system comprising: a processor; a memory coupled to the processor; and instructions provided to the memory, wherein the instructions are executable by the processor to cause the system to perform a method comprising: describing governing equations of an additive manufacturing process; refactoring the governing equations into (1) constitutive laws with unknown coefficients and (2) conservation laws; discretizing the governing equations; and training the unknown coefficients of the constitutive laws with simulated data and/or experimental data relating to the additive manufacturing process where the conservation laws are enforced in the training regardless of a granularity of the constitutive laws, thereby yielding a reduced-order set of governing equations.

### BRIEF DESCRIPTION OF THE DRAWINGS

The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 illustrates a nonlimiting example method of the present disclosure.

FIG. 2 illustrates another nonlimiting example method of the present disclosure.

FIG. 3 illustrates a nonlimiting example method for generating a scale-aware reduced-order multi-physics model of the present disclosure.

FIG. 4 illustrates several frames of a high-fidelity model for additive manufacturing for falling droplet impacting and solidifying on a substrate.

FIG. 5 illustrates similarly a droplet falling, impact, solidification, and coalescence but, in contrast to FIG. 4, is for a lumped parameter model, an example of a reduced-order multi-physics model according to at least one embodiment of the present disclosure.

### DETAILED DESCRIPTION

The present disclosure relates to systematically developing reduced-order (e.g., upscaled or coarse-grained, lumped- or distributed-parameter) multi-physics models for simulating additive manufacturing. The reduced-order multi-physics models are courser-grained model with fewer equations, describing the aggregate behavior of integral properties over larger regions of space and/or time, as compared to the high-fidelity computational fluid/solid dynamics simulations. Accordingly, the reduced-order multi-physics models are significantly faster than high-fidelity computational fluid/solid dynamics simulations. Further, the level of granularity in the reduced-order multi-physics models may be adjusted to achieve a desired computational time, relative to the computational power available, and allow for performing additive manufacturing simulations of complete parts in a reasonable amount of time (e.g., minutes to hours on commodity hardware). This significantly improves additive manufacturing technology because as-printed shapes and material properties can be predicted from an additive manufacturing process parameters in a reasonable amount of time. This allows for fine-tuning the additive manufacturing process parameters to achieve the desired as-printed shapes and material properties in both simple and complex parts.

The reduced-order multi-physics models described herein are hybrid models that use a combination of non-negotiable first principles (e.g., conservation laws or symmetries) that are postulated and phenomenological relations (e.g., constitutive laws) that are learned from experimental data. The advantage of the former is that the models are guaranteed by construction to respect the first principles that are key to predictive accuracy. Moreover, they constrain the models to enable training with fewer and sparser data points, which is advantageous when experiments are difficult, expensive, and time-consuming.

The reduced-order multi-physics models may be applied to various additive manufacturing processes including, but not limited to, material extrusion (e.g., fuse deposition modelling (FDM)), powder bed fusion (e.g., direct metal laser sintering (DMLS), electron beam melting (EBM), selective heat sintering (SHS), selective laser melting (SLM), and selective laser sintering (SLS)), material jetting (e.g., continuous jetting and drop-on-demand jetting using liquid metals, liquid polymers, or the like), binder jetting, or directed energy deposition (e.g., laser engineered net shaping, directed light fabrication, direct metal deposition, and 3D laser cladding). Example of materials that may be used in said additive manufacturing processes may include, but are not limited to, polymers (e.g., polyamide, polyolefins, polyurethanes, polyesters, poly(meth)acrylamides, and the like, and any blends thereof), metals (e.g., aluminum, cobalt, copper, nickel, silver, gold, titanium, tantalum, alloys comprising one or more of the foregoing, steels and the like), and the like.

### Generating and Applying Reduced-Order Multi-Physics Models

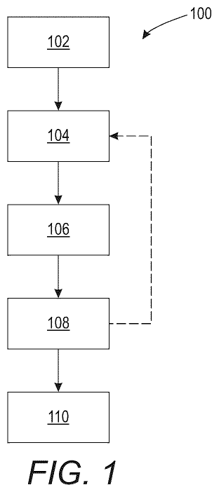

FIG. 1 illustrates a nonlimiting example method 100 of the present disclosure. In a first step 102, additive manufacturing data is provided (e.g., about the materials (e.g., melting point, viscosity as a function of temperature, or any combination thereof), the additive manufacturing parameters (e.g., temperature, pressure, laser power, scan rate, material deposition rate, or any combination thereof), and the effects of the additive manufacturing process on the materials (e.g., changes in shape, rate of solidification, or any combination thereof). In a second step 104, an initial set of hyper-parameters such as window size w and polynomial order o are selected. The additive manufacturing data is then split, in a third step 106, into training data set and test data set. Common practices in machine learning may be used to split the data. In the fourth step 108, the training data set is then used to train a scale-aware reduced-order multi-physics model (described in more detail herein) using machine learning techniques, and the test data set is used to test the trained scale-aware reduced-order multi-physics model. If the train/test errors are not acceptable (or in the special linear case, the correlation is weak) and the noise is perceived to be a problem, go back to the second step 104 and change the parameters and try again. Steps 104-108 are then repeated until a satisfactory fit is obtained. Then, the coefficient distribution (e.g., spatial field for speed of sound) from the satisfactory fit may be used in a fifth step 110 to model an additive manufacturing process.

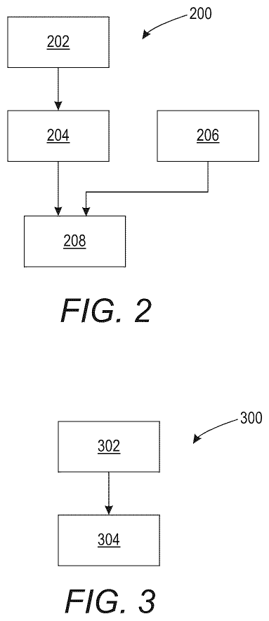

FIG. 2 illustrates a nonlimiting example method 200 of the present disclosure, which may include: performing 202 an additive manufacturing process; measuring 204 data relating to the additive manufacturing process (e.g., droplet shape, droplet reaction (or change in shape) when encountering a surface, solidification of a droplet, molten pool properties and/or dimensions, and the like); selecting 206 at least one of a specific length scale or a specific time scale; and modeling 208 a second additive manufacturing process with the scale-aware reduced-order multi-physics model, wherein the scale-aware reduced-order multi-physics model is based on the at least one of the specific length scale or the specific time scale. As described further herein, the scale-aware reduced-order multi-physics model comprises data-trained governing equations that enforce conservation laws relating to the material regardless of a level of granularity of constitutive laws in the governing equations.

A method for generating reduced-order multi-physics models may comprise: describing an additive manufacturing process with symbolic partial differential equations (PDEs); refactoring the symbolic PDEs into (1) conservation laws, which may take different forms depending on the lumped- or distributed-parameter setting and (2) constitutive laws that can be parameterized with unknown lumped or distributed parameters (i.e., coefficients); training the unknown coefficients of the constitutive laws with simulated data, experimental data, or any combination of them relating to the additive manufacturing process where the conservation laws are enforced regardless of the granularity at which the constitutive laws are described. Expressing the conservation and constitutive laws in the infinitesimal limit (i.e., choosing infinitely small length/time scales) leads to ordinary or partial differential equations (ODEs/PDEs), while choosing finite length and/or time scales leads to integral or integro-differential (IEs/IDEs) with the same conservation principles satisfied exactly and in a scale-agnostic fashion, while constitutive laws are scale-aware.

FIG. 3 illustrates a nonlimiting example method 300 for generating a scale-aware reduced-order multi-physics model, which may comprise: describing 302 an additive manufacturing process with (1) conservation laws, which must hold in integral form regardless of the choice of the length scale and/or the time scale (e.g., the at least one of the specific length scale or the specific time scale selected 206 in FIG. 2 or selected separately and then used to define the at least one of the specific length scale or the specific time scale in the method of FIG. 2) and (2) constitutive laws that can be parameterized with unknown coefficients at given length scales and/or time scales; and determining 304 (e.g., optimizing using fits that minimize one or more errors and/or using machine learning minimize one or more errors) the unknown coefficients of the constitutive laws with data (e.g., simulated data, experimental data, or any combination thereof) relating to the additive manufacturing process where the conservation laws are enforced regardless of the granularity at which the constitutive laws are described.

Expressing the conservation and constitutive laws in the infinitesimal limit (i.e., choosing infinitely small length scales and/or time scales) leads to ordinary or partial differential equations (ODEs/PDEs), while choosing finite length and/or time scales leads to integral or integro-differential (IEs/IDEs) with the same conservation principles satisfied exactly and in a scale-agnostic fashion, while constitutive laws are scale-aware. These equations may be accompanied with initial and/or boundary conditions (ICs/BCs). These different forms of equations, representing the scale-aware reduced-order multi-physics models (including infinitesimal and finite scales, in space and/or time) are hereafter referred to as symbolic equations. The symbolic equations can be automatically generated from first principles using interaction networks (I-nets), as described in U.S. patent application Ser. No. 17/684,100, which is incorporated herein in its entirety by reference.

As used herein, the term “conservation” laws/principles refers to laws of physics, whose scale-agnostic structure can be derived directly from the mathematical (particularly, topological) properties of space and time, such as conservation of mass, conservation of mechanical or thermal energy, conservation of momentum, conservation of electrical charge, and the like.

As used herein, the term “constitutive laws” refers to phenomenological relationships between two or more physical quantities that may be specific to a material or substance over a given region or space or time. These laws cannot be derived mathematically, must be measured empirically, and depend on length scales and time scales. Unlike conservation laws that include differentiation and integration due to their topological nature, constitutive laws are of algebraic nature and are typically “in-place” (i.e., do not related regions of space and time to their boundaries).

Constitutive laws may comprise an equation or series of equations that are parameterized by coefficients that must be determined from experiments. These coefficients may change depending on the region of space and/or time over which they are defined (i.e., heterogeneity in space/time). For example, constitutive laws may describe one or more properties of the material like elasticity, viscosity, conductivity, heat capacity, phase (e.g., solid or liquid), or any combination thereof (i.e., the stress/strain relationships, stress/strain-rate relationships, temperature/phase relationships, temperature/viscosity relationships) or how such relationships change with temperature, over a given 3D volume. In another example, constitutive laws may describe the relationship between heat flux and temperature gradient over a given 2D surface.

The constitutive laws may comprise a single-physics constitutive relation and/or a multi-physics coupling interaction. That is, constitutive laws may comprise a relationship (e.g., in the form of an equation or series of equations approximating the said relationship) between one or more properties of a material as a function of one or more coefficients.

For computational purposes, including fitting the coefficients of scale-aware constitutive laws, symbolic equations may involve discretizing and/or semi-discretizing the equations in space and/or time. For example, semi-discretizing a PDE in space (e.g., over a mesh) yields a system of ODEs. Discretizing the ODEs further in time yields an even larger system of algebraic equations with coefficients that can be computed by regression.

Relative to the conservation laws, examples of discretizing methods may include, but are not limited to, finite difference/volume/elements schemes, mimetic schemes, spectral schemes, meshfree/meshless (e.g., point cloud) schemes, immersed boundary methods, neural field parameterizations, and the like. The discretized conservation laws may be stated in terms of exact balance equations among integral quantities such as surface fluxes and volumetric source/sink terms on cells of various dimensions in a 3D mesh, or unions of such cells in a coarse-grained mesh. The discretization resolution (i.e., size of mesh cells or period of time steps) does not produce any error in the conservation laws as the balance equations are exact for every finite region of space and/or time. Hence, one can gain significant speed-ups by using a coarse-grained mesh with fewer (but larger) cells, leading to a smaller number of equations.

In the absence of noise, integral forms of conservation laws are exact on finite regions of space and time, meaning that the integration-based discretization in space and time, as long as it is “physics-compatible” (e.g., consistent with the topological nature of the discretized quantities described in The Mathematical Structure of Classical and Relativistic Physics, by Enzo Tonti, 2013, Part of the Modeling and Simulation in Science, Engineering and Technology book series) does not produce any errors in the conservation laws (e.g., balance of momentum density with internal/external stresses and momentum density variations in time). However, the constitutive laws that, for example, relate momentum density to velocity (via inertia) or an elastic or visco-elastic stresses to strains or strain rates (via elasticity and viscosity) depend on the length scale and/or time scale at which these phenomena are observed. These laws are empirical and are parameterized by material properties such as density, elasticity, and viscosity that are measured by experimenting on material specimens.

Once the symbolic equations are discretized, the unknown coefficients may be fit (e.g., determined 204 of FIG. 2) to data from high-fidelity simulations and/or experiments, using any number of regression, curve fitting, or machine learning techniques. Simulated data may be obtained, for example, by integration over the solutions of high-fidelity simulations using a much finer-grained mesh, to obtain “effective” constitutive laws over coarser-grained cells in space (and similarly in time). These effective constitutive laws can be parametrized with a linear combination of nonlinear basis functions or nonlinear neural parametrizations, to account for the geometric complexities within the larger cells, even if the original constitutive laws over the smaller cells happened to be linear.

The unknown coefficients used in the parameterization of the effective constitutive relations can be computed (e.g., determined 204 of FIG. 2) by expressing the discretized equations as feed-forward neural networks whose layers represent the integral forms of differential operators as well as in-place nonlinear functions for the effective constitutive relations. The neural network structure computes the residual error of the discretized equation over different regions of space and time, for a given set of coefficient values (i.e., neural network weights). These coefficients may be learned from data (e.g., simulated and/or experimental data) to minimize a global residual error. The implementation typically includes two sequences of tensor-based computations in parallel, one for evaluating spatial differential operators (or their integral forms) such as gradient and divergence, accompanied by integrations in time, and one for evaluating temporal differential operators (or their integral forms) such as time derivative, accompanied by integrations in space. This approach is referred to herein as effective equation fitting (EEF).

An alternative approach is to implement the temporal integration (i.e., time stepping) that solves the initial/boundary value problem for the scale-aware reduced-order multi-physics model akin to using a recurrent neural network. In this case, the objective is to minimize the difference between the simulation results and the given data. In other words, the solution error is used as the objective function as opposed to the equation error used in EEF. This approach is referred to herein as effective solution fitting (ESF).

For example, the local dynamics of droplet coalescence in drop-on-demand (DoD) liquid metal jetting (LMJ) requires coupling conservation of mass (i.e., continuity and multi-phase flow), conservation of momentum, and conservation of thermal energy, as well as various constitutive laws for inertia, elasticity, viscosity, conductivity, phase change, etc. The differential form of these equations (i.e., distributed-parameter model with infinitesimal length/time scales) reduce to a system of PDEs comprising incompressible Navier-Stokes equations, phase-field equations, Fourier's heat equation, and solidification (e.g., Lee model). However, the same principles can be interpreted in integral form for a spatially coarse-grained distributed-parameter Eulerian model, in which the PDEs are replaced with IDEs in which the conservation laws are applied to larger mesh elements in 3D space and the original constitutive laws are replaced with coarse-grained “effective” counterparts that are nonlinear and data-driven.

Alternatively, a lumped-parameter Lagrangian model can be developed, in which the conservation of mass is satisfied by construction (due to invariant number and mass of lumped “super-particles”), conservation of momentum is replaced with a Newtonian balance of forces and momentum rates of change for the lumped super-particles, while heat transfer and solidification equations are replaced with their lumped counterparts as well. In the constitutive equations, distributed elasticity, viscosity, conductivity and the like are replaced with virtual springs, dampers, conductors, and the like.

For either of the two (distributed- and lumped-parameter) reduced-order models, the EEF and ESF can be applied to quantify the “effective” constitutive properties.

EEF is often faster than ESF because the latter needs to solve the governing equations iteratively as in inner-loop, in addition to the error minimization (i.e., training) outer-loop; while the former is a simple forward evaluation of the governing equations (i.e., no inner-loop). However, ESF is generally more reliable for highly nonlinear systems in which small equation error does not necessarily imply small solution error, which is the ultimate metric for accuracy of the coarse-graining. Moreover, in many practical problems, the state variables (e.g., displacement field in the above example) are not directly measured to be substituted in the equations for evaluating residual errors. Rather, one has to fit the coefficients to minimize the error in observables, which depend on the state variables. If this dependence cannot be inverted, EEF cannot be applied, making ESF the only viable option among the two.

If the tenor computations are implemented using machine learning frameworks (e.g., PyTorch or TensorFlow), the minimization process for both EEF and ESF can be implemented using numerous optimizers for backpropagation of errors (e.g., stochastic gradient descent (SGD), ADAM, AdaGrad, RMSprop, and the like) that are popular in machine learning, taking advantage of the automatic differentiation capabilities of machine learning frameworks (e.g., PyTorch, TensorFlow, Keras, and JAX).

The resultant ODEs consisting of conservation laws, derived from first principles, and constitutive laws with estimated coefficients via EEF or ESF make up the governing equations of the reduced-order multi-physics model.

Once a reduced-order multi-physics model is produced for an additive manufacturing process (e.g., material extrusion, powder bed fusion, material jetting, binder jetting, or directed energy deposition), said reduced-order multi-physics model may then be used to simulate additive manufacturing of parts for given build recipes and tool paths, and enable qualification of processes and parts, reduction of trial-and-error cycles to achieve to the desired quality, redesign parts, improve 3D printing process by redesigning the printer or optimizing the process, and the like.

The methods described herein for generating scale-aware reduced-order multi-physics models useful in modeling an additive manufacturing process (e.g., material extrusion, powder bed fusion, material jetting, binder jetting, or directed energy deposition) are, at least in part, performed using computing devices or processor-based devices that include a processor; a memory coupled to the processor; and instructions provided to the memory, wherein the instructions are executable by the processor to perform the methods described herein.

Further, any calculation, determination, or analysis recited as part of methods described herein may be carried out in whole or in part using a computer. The methods described herein for generating a reduced-order multi-physics model and/or simulating an additive manufacturing process using a reduced-order multi-physics model are performed using computing devices or processor-based devices that include a processor; a memory coupled to the processor; and instructions provided to the memory, wherein the instructions are executable by the processor to perform the methods described herein (such computing or processor-based devices may be referred to generally by the shorthand “computer”). Methods and systems for producing a part also include computing devices that direct the additive manufacturing device. Methods and systems of the present disclosure may have separate or the same computing devices for performing one or more of: generating a reduced-order multi-physics model, simulating an additive manufacturing process, and causing an additive manufacturing device to produce a part.

Furthermore, the instructions of such computing devices or processor-based devices can be a portion of code on a non-transitory computer readable medium. Any suitable processor-based device may be utilized for implementing all or a portion of embodiments of the present techniques, including without limitation personal computers, networks, personal computers, laptop computers, computer workstations, mobile devices, multi-processor servers or workstations with (or without) shared memory, high performance computers, and the like. Moreover, embodiments may be implemented on application specific integrated circuits (ASICs) or very large scale integrated (VLSI) circuits.

“Computer-readable medium” or “non-transitory, computer-readable medium,” as used herein, refers to any non-transitory storage and/or transmission medium that participates in providing instructions to a processor for execution. Such a medium may include, but is not limited to, non-volatile media and volatile media. Non-volatile media includes, for example, NVRAM, or magnetic or optical disks. Volatile media includes dynamic memory, such as main memory. Common forms of computer-readable media include, for example, a floppy disk, a flexible disk, a hard disk, an array of hard disks, a magnetic tape, or any other magnetic medium, magneto-optical medium, a CD-ROM, a holographic medium, any other optical medium, a RAM, a PROM, and EPROM, a FLASH-EPROM, a solid state medium like a memory card, any other memory chip or cartridge, or any other tangible medium from which a computer can read data or instructions. When the computer-readable media is configured as a database, it is to be understood that the database may be any type of database, such as relational, hierarchical, object-oriented, and/or the like. Accordingly, exemplary embodiments of the present systems and methods may be considered to include a tangible storage medium or tangible distribution medium and prior art-recognized equivalents and successor media, in which the software implementations embodying the present techniques are stored.

Once a reduced-order multi-physics model is produced for an additive manufacturing process (e.g., material extrusion, powder bed fusion, material jetting, binder jetting, or directed energy deposition), said reduced-order multi-physics model may then be used to simulate additive manufacturing and provide a variety of outputs to a user.

The methods described herein for generating a reduced-order multi-physics model and/or simulating an additive manufacturing process using a reduced-order multi-physics model are performed using computing devices or processor-based devices that include a processor; a memory coupled to the processor; and instructions provided to the memory, wherein the instructions are executable by the processor to perform the methods described herein (such computing or processor-based devices may be referred to generally by the shorthand “computer”). Methods and systems for producing a part also include computing devices that direct (or send instructions with the additive manufacturing parameters needed for producing the part to) the additive manufacturing device coupled (wired or wirelessly thereto). Methods and systems of the present disclosure may have separate or the same computing devices for performing one or more of: generating a reduced-order multi-physics model, simulating an additive manufacturing process, and causing an additive manufacturing device to produce a part.

Similarly, any calculation, determination, or analysis recited as part of methods described herein may be carried out in whole or in part using a computer.

Furthermore, the instructions of such computing devices or processor-based devices can be a portion of code on a non-transitory computer readable medium. Any suitable processor-based device may be utilized for implementing all or a portion of embodiments of the present techniques, including without limitation personal computers, networks, personal computers, laptop computers, computer workstations, mobile devices, multi-processor servers or workstations with (or without) shared memory, high performance computers, and the like. Moreover, embodiments may be implemented on application specific integrated circuits (ASICs) or very large scale integrated (VLSI) circuits.

“Computer-readable medium” or “non-transitory, computer-readable medium,” as used herein, refers to any non-transitory storage and/or transmission medium that participates in providing instructions to a processor for execution. Such a medium may include, but is not limited to, non-volatile media and volatile media. Non-volatile media includes, for example, NVRAM, or magnetic or optical disks. Volatile media includes dynamic memory, such as main memory. Common forms of computer-readable media include, for example, a floppy disk, a flexible disk, a hard disk, an array of hard disks, a magnetic tape, or any other magnetic medium, magneto-optical medium, a CD-ROM, a holographic medium, any other optical medium, a RAM, a PROM, and EPROM, a FLASH-EPROM, a solid state medium like a memory card, any other memory chip or cartridge, or any other tangible medium from which a computer can read data or instructions. When the computer-readable media is configured as a database, it is to be understood that the database may be any type of database, such as relational, hierarchical, object-oriented, and/or the like. Accordingly, exemplary embodiments of the present systems and methods may be considered to include a tangible storage medium or tangible distribution medium and prior art-recognized equivalents and successor media, in which the software implementations embodying the present techniques are stored.

### Nonlimiting Example Reduced-Order Multi-Physics Model (Lumped Parameter Model)

In this example, a lumped parameter model is used as the reduced-order multi-physics model for modeling droplet falling, impact, and coalescence. The droplet can be modeled by an inter-connected network of “artificial” particles. These particles may not be representative of actual material particles (e.g., atoms or molecules) but rather geometric points that serve two purposes: (1) parameterizing the shape and kinematics of a droplet by particle coordinates and their time derivative (i.e., positions and velocities); and (2) carrying physical quantities such as lumped mass, phase fraction, and temperature.

It may be assumed that a three-dimensional (3D) setting, although everything here can be repeated with little modification for arbitrary number of dimensions. The code can be implemented for 2D for ease of illustration and faster geometric algorithms (e.g., Delaunay triangulation) but can be easily updated to 3D.

Lumped Network Topology: Consider n≥2 particles, indexed by i=0, 1, . . . , (n−1). The particles may be assumed to interact in a pairwise fashion, both mechanically and thermally (i.e., the presence of a third particle does not affect the force or heat flux exchanged between a pair of particles). The pairwise interactions may be captured by a directed graph G=(V, E), where |V|=n and |E|=m≤n(n−1)/2. The edge set E changes with time as a function of particle positions (i.e., particles that are closer to one another interact, hence have an edge in the instantaneous graph at a given time step).

One vertex vᵢ∈V may be assigned per particle and indexed by i=0, 1, . . . , n; and one directed edge eⱼ:=(vᵢ₁, vᵢ₂)∈E may be assigned per interaction and indexed by j=0, 1, . . . , (m−1). The indexing of edges can be in any order. The directions are needed because of the way the governing equations are written, and the directions are arbitrary as long as they are consistent throughout the computations only for a single time-step. Without loss of generality, the edges may be directed from lower particle index to higher particle index (i.e., i₁<i₂). The inequality also implies that there are no loops (i.e., a particle cannot interact with itself).

Vertex and Edge Variables: Each particle (i.e., graph vertex vᵢ∈V) may be assigned with the following “lumped” variables:
absolute position xᵢ(t)∈ [symbol] ³;
absolute velocity vᵢ(t)∈ [symbol] ³, i.e., time derivative of absolute position;
absolute temperature Tᵢ(t∈ [symbol] ;
phase fraction φᵢ(t)∈[0, 1] which represents the percentage of solidified material (e.g., φᵢ(t)=0.3 means 30% solid, 70% liquid, co-existing in the same location);
rate of change of phase fraction ψᵢ(t)∈ [symbol] i.e., time derivative of phase fraction;
vertex membership class χᵢ(t)∈{0, 1} which labels interior particles by 0 and boundary particles (air or ground contact alike) by 1; and
ground contact class ηᵢ(t)∈{0, 1} which labels particles that touch the ground by 1 and those that do not by 0.

At every time step t∈[0, tₘₐₓ], the vector variables with 3 components may be arranged in n×3 arrays [xᵢ(t)] and [vᵢ(t)] and the scalar variables in n×1 arrays [Tᵢ(t)], [φᵢ(t)], and [χᵢ(t)].

Each interaction (i.e., graph edge eⱼ=(vᵢ₁, vᵢ)∈E) may be assigned with the following variables:
relative position x̅ⱼ(t)=(xᵢ₂(t)−xᵢ₁(t))∈ [symbol] ³;
relative velocity v̅ⱼ(t)=(vᵢ₂(t)−vᵢ₁(t))∈ [symbol] ³, i.e., time derivative of relative position;
relative temperature T̅ⱼ(t)=(Tᵢ₂(t)−Tᵢ₁(t))∈ [symbol] ;
average phase fraction \tilde{φ}ⱼ(t)=½ (φᵢ₁(t)+φᵢ₂(t))∈[0,1];
edge density ρⱼ(t)∈{0, 1} which is set to 1 if the edge exists in the graph at a given time step and 0 if it does not;
modified edge density \hat{ρ}ⱼ(t)∈[0,1] which is a density-like smoothed representation of its existence (e.g., \hat{ρ}ⱼ(t)=0.6 means every interaction such as pairwise force or heat flux is weakened by 60%) (Note that this has nothing to do with mass density. The mass is uniformly lumped among particles, and never appears as a parameter because we work with non-dimensionalized equations); and
edge membership class γⱼ(t)∈{0, 1} which labels interior edges by 0 and boundary edges (air or ground contact alike) by 1.

At every time step t∈[0, tₘₐₓ], the vector variables with 3 components may be arranged in m×3 arrays [x̅ⱼ(t)] and [v̅ⱼ(t)] and the scalar variables in m×1 arrays [T̅ⱼ(t)], [\tilde{φ}ⱼ(t)], [ρⱼ(t)], and [γⱼ(t)]. Note that “absolute” variables belong to particles in contrast to “relative” variables that belong to their pairwise differences.

Differencing and Interpolation: The graph connectivity may be fully specified in terms of an incidence matrix, which is an m×n matrix [δ_{j,i}] defined as follows:

$$\begin{matrix}+ 1 & if {e}_{j} = ( {v}^{′} , {v}_{i} ) for some {v}^{′} ∈ V , \\ {δ}_{j , i} = - 1 & if {e}_{j} = ( {v}_{i} , {v}^{′} ) for some {v}^{′} ∈ V , \\ 0 & otherwise .\end{matrix} \qquad ( 1 )$$

In simpler terms, the incidence matrix element δ_{i,j}+±1 if the vertex vᵢ∈V and edge eⱼ∈E are incident, i.e., eⱼ=(v′, vᵢ) or eⱼ=(vᵢ, v′), and the sign is determined by the order. Each vertex may be thought of as a sink, and the sign is determined by whether the edge direction agrees with the vertex direction (incoming: +) or disagrees with the vertex direction (outgoing: −).

One should not confuse incidence matrix with the more commonly used adjacency matrix, which is an n×n square-matrix [A_{i1,i2}] defined by A_{i1,i2}=±1 if (vᵢ₁, vᵢ₂)∈E or (vᵢ₂, vᵢ₁)∈E and zero otherwise. In this example, adjacency matrices may not be needed for computation, although incidence matrices can be reproduced from therefrom.

The “relative” edge variables can be computed from “absolute” vertex variables by a so-called co-boundary operation, which is simply a left action by the incidence matrix:

[x̅ⱼ]=[δ_{j,i}][xᵢ], i.e., x̅ⱼ=Σᵢ₌₀ⁿ⁻¹δ_{j,i}xᵢ, for j=0,1, . . . ,(m−1), (2)

[v̅ⱼ]=[δ_{j,i}][vᵢ], i.e., v=Σᵢ₌₀ⁿ⁻¹δ_{j,i}vᵢ, for j=0,1, . . . ,(m−1), (3)

[T̅ⱼ]=[δ_{j,i}][Tᵢ], i.e., T̅ⱼ=Σᵢ₌₀ⁿ⁻¹δ_{j,i}Tᵢ, for j=0,1, . . . ,(m−1). (4)

It is called co-boundary because it linearly maps values from every given vertex to the edges whose “boundary” (i.e., two incident vertices) contains the given vertex. Every edge receives a signed sum of values coming from its two boundary vertices, the sign being determined by the relative orientation (remember vertices are sinks and edges are directed arrows). The co-boundary operator is fundamental in algebraic topology.

An m×n interpolation matrix [I_{j,i}] can also be defined as follows:

$$\begin{matrix}\frac{1}{2} & if {e}_{j} = ( {v}^{′} , {v}_{i} ) for some {v}^{′} ∈ V , \\ {I}_{j , i} = \frac{1}{2} & if {e}_{j} = ( {v}_{i} , {v}^{′} ) for some {v}^{′} ∈ V , \\ 0 & otherwise .\end{matrix} \qquad ( 5 )$$

Then the average edge variables may be computed from corresponding vertex variables as follows:

[\tilde{φ}ⱼ]=[I_{j,i}][φᵢ], i.e., \tilde{φ}ⱼ=Σᵢ₌₀ⁿ⁻¹I_{j,i}φᵢ, for j=0,1, . . . ,(m−1) (6)

For membership classification, [γⱼ]=[I_{j,i}][χᵢ] may be used, which produced γⱼ=0 for edges whose both vertices are inside, γⱼ=½ for edges whose one vertex is inside and the other vertex is on the boundary, and γⱼ=1 for edges whose both vertices are on the boundary. Then, subsequently convert all ½ to 0.

Update Rules for Topology: The graph topology changes with time (i.e., E=E(t)), hence the incidence relations must be updated with time (i.e., δ_{j,i}=δ_{j,i}(t) and I_{j,i}=I_{j,i}(t)). It is reasonable to assume proximity to play an important role in connectivity, i.e., particles that are close to each other interact, hence in general topology is a function of instantaneous particle positions: E(t)= [symbol] ([xᵢ(t)]).

This examples used α-complexes for the [symbol] -function, although any other rule (e.g., fully connected graphs, connect only k-nearest-neighbors, or connect particles that are within a pre-defined fixed cut-off distance) may be used and this example remains valid.

The α-complex may be a subcomplex of Delaunay triangulation in which triangles with circumcircles larger than 1/α are eliminated. The outer boundary of the complex is the convex hull for Delaunay triangulation obtained by setting α:=0 and a so-called concave hull otherwise, whose concavity is adjusted by α>0.

To simplify, the edge set E can be fixed to a maximal set over the entire course of simulation, so that the matrices maintain their size and structure. This makes array-based computation (e.g., PyTorch “tensors”) more efficient to have arrays of static size as opposed to changing them at every time step during training. Instead of explicitly eliminating edges from the indexed set E, every time the α-complex (or any other instantaneous graph) is generated at a given time t∈[0, tₘₐₓ], the edges eⱼ∈E that are not present are implicitly eliminated by setting their density values ρⱼ(t):=0. In other words, the placeholders may be kept for all edges that might appear at some point in the simulation, and zero-out the physical effects (e.g., pairwise force or heat flux) for the ones that are temporarily absent at a given time step.

The maximal set need not be a fully-connected set with m=|E|=n(n−1)/2=(n²), which results in memory blow-up for large number of particles. It can be hypothesized that most particles will interact with only a few (i.e., O(1)) other particles throughout the course of simulation, although these neighbors keep changing from one time step to the next. Hence, if the potential neighbors for every particle is known, for example, by pre-processing the training data set and computing [symbol] ([xᵢ(t)]), we can use a maximal set E=U_{t∈[0,t}_{ₘₐₓ}_{]} [symbol] ([xᵢ(t)]) (or a discrete union over finite number of time steps). Provided that m=|E|=O(n) edges, the matrices will not require quadratic memory.

Each edge eⱼ=(vᵢ₁, vᵢ₂)∈E provisioned as a placeholder for interaction of particles may be assigned to vᵢ₁∈V and vᵢ₃∈V has a density of ρⱼ(t)=1 or 0, depending on whether the pair of particles interact at the given time step or not, respectively. This value is determined by the triangulation algorithm (the [symbol] -function above) that is called at every time step depending and consumes particle positions from previous time step. The “modified” density may be then computed as follows:

\hat{ρ}ⱼ=½\hat{ρ}ⱼ(1−tanh α^{cut}(∥x̅ⱼ∥₂−L^{cut})), for j=0,1, . . . ,(m−1). (7)

The hyperbolic tangent function may be used as a smoothed step function, where α^{cut}∈(0, ∞) determines the slope of transition from 1 to 0. It ensures that the edges whose lengths are larger than L^{cut}∈(0, ∞) decay in their modified density (hence, proportionally in the intensity of spring, damper, and conductor parameters) at a rate determined by α^{cut} thus (α^{cut}, L^{cut}) are parameters of constitutive laws (or phenomenological parameters) learned from data.

Constitutive Equations: The relative positions, velocities, and temperatures determine pairwise spring forces, damper forces, and heat fluxes, respectively. For mechanical modeling, the following constitutive equations may be used that determine the pairwise elastic forces f̅ⱼ^{e}, capillary forces f̅ⱼ^{c}, and viscosity forces f̅ⱼ^{v}:

f̅ⱼ^{e}=−kⱼ(x̅ⱼ·eⱼ−Lⱼ^{eq})eⱼ, for j=0,1, . . . ,(m−1), (8)

f̅ⱼ^{c}=−cⱼ(xⱼ·eⱼ)eⱼ, for j=0,1, . . . ,(m−1), (9)

f̅ⱼ^{v}=−bⱼ(vⱼ·eⱼ)eⱼ, for j=0,1, . . . ,(m−1), (10)

where eⱼ=x̅ⱼ/∥x̅ⱼ∥₂ is the unit vector along the edge, hence x̅ⱼ·eⱼ=∥x̅ⱼ∥₂ is the edge length and v̅ⱼ·eⱼ is the tangential component of relative velocity, which are used to compute spring and damper forces for every edge. All edges have an elastic tensile or compressive force, depending on whether the edge length is larger or smaller than the equilibrium length Lⱼ^{eq}. Only boundary edges that are in contact with air or ground experience a capillary (i.e., surface tension) force that is always tensile, i.e., has zero equilibrium length.

For thermal modeling, similarly, the following constitutive equation determines the pairwise heat fluxes q̅ⱼ:

q̅ⱼ=−λⱼT̅ⱼeⱼ, for j=0,1, . . . ,(m−1). (11)

The stiffness coefficients kⱼ and cⱼ, damping coefficients bⱼ, conduction coefficients λⱼ, and equilibrium lengths Lⱼ^{eq}, are all functions of phase. Following common practice in CFD, one can linearly interpolate between liquid and solid phases as follows:

k*ⱼ=k_{L}+(k_{S}−k_{L})\tilde{φ}ⱼ=(1−+\tilde{φ}ⱼ)k_{L}+\tilde{φ}ⱼk_{S}, for j=0,1, . . . ,(m−1), (12)

c*ⱼ=c_{L}+(c_{S}−c_{L})\tilde{φ}ⱼ=(1−+\tilde{φ}ⱼ)c_{L}+\tilde{φ}ⱼc_{S}, for j=0,1, . . . ,(m−1), (13)

b*ⱼ=b_{L}+(b_{S}−b_{L})\tilde{φ}ⱼ=(1−+\tilde{φ}ⱼ)b_{L}+\tilde{φ}ⱼb_{S}, for j=0,1, . . . ,(m−1), (14)

λ*ⱼ=λ_{L}+(λ_{S}−λ_{L})\tilde{φ}ⱼ=(1−+\tilde{φ}ⱼ)λ_{L}+\tilde{φ}ⱼλ_{S}, for j=0,1, . . . ,(m−1), (15)

L*ⱼ^{eq}=L_{L}^{eq}+(L_{S}^{eq}−L_{L}^{eq})\tilde{φ}ⱼ=(1−+\tilde{φ}ⱼ)L_{L}^{eq}+\tilde{φ}ⱼk_{S}^{eq}, for j=0,1, . . . ,(m−1), (16)

where (k_{L}, k_{S}), (c_{L}, c_{S}), (b_{L}, b_{S}), (λ_{L}, λ_{S}), and (L_{L}^{eq}, L_{S}^{eq}) are liquid and solid “virtual” material properties, respectively, and are assumed to be constants that can be learned from data. The asterisk (*) means uncorrected parameters. Some of the above parameters must be corrected by multiplying them by the modified edge density \hat{ρ}ⱼ∈[0,1] computed earlier by tanh-modification, which weakens the parameter linearly with a measure of the edge's existence:

kⱼ=k*ⱼ\hat{ρ}ⱼ, for j=0,1, . . . ,(m−1), (17)

cⱼ^{†}=c*ⱼ\hat{ρ}ⱼ, for j=0,1, . . . ,(m−1), (18)

bⱼ=b*ⱼ\hat{ρ}ⱼ, for j=0,1, . . . ,(m−1), (19)

λⱼ=λ*ⱼ\hat{ρ}ⱼ, for j=0,1, . . . ,(m−1), (20)

The capillary coefficient requires an additional correction:

cⱼ=cⱼ^{†}γⱼ, for j=0,1, . . . ,(m−1), (20)

so the surface tension forces are zeroed out for interior edges with γⱼ=0, and remain unchanged for boundary edges with γⱼ=1.

External Effects: There are also constitutive equations that are expressed directly on vertices to capture external effects, including source terms and boundary conditions. For mechanical boundary conditions, the following constitutive equations may be used that determine the ground elastic reaction forces fᵢ^{ge}, ground viscous friction forces fᵢ^{gv}, and air drag fᵢ^{ad}:

fᵢ^{ge}=+kᵢ^{g}(xᵢ·z)z, for i=0,1, . . . ,(n−1), (22)

fᵢ^{gv}=−bᵢ^{g}vᵢ, for i=0,1, . . . ,(n−1), (23)

fᵢ^{ad}=−bᵢ^{a}vᵢ, for i=0,1, . . . ,(n−1), (24)

where z=(0, 0, 1) is the unit upward vector. It may be assumed, for now, that the ground is a flat plane at z=0. In future, this model can be extended to capture arbitrary ground profile by replacing (xᵢ·z) with a distance function to the ground profile. The friction model may require updating as well to distinguish between normal and tangential components of velocity and reaction forces.

For thermal boundary conditions, similarly, we have the following constitutive equations that determine ground conduction flux qᵢ^{g} and air convection flux qᵢ^{a}:

qᵢ^{g}=−λᵢ^{g}(Tᵢ−T^{g}), for i=0,1, . . . ,(n−1), (25)

qᵢ^{a}=−λᵢ^{a}(Tᵢ−T^{a}), for i=0,1, . . . ,(n−1), (26)

where T^{g}, T^{a}∈ [symbol] are the ground and air temperatures, assumed constant and known (i.e., not subject to learning).

Once again, the ground stiffness coefficients kᵢ^{g}, ground damping coefficients bᵢ^{g}, air drag coefficients bᵢ^{a}, ground conduction coefficients λᵢ^{g}, and air convection coefficients λᵢ^{a} can be interpolated as a function of the phase:

kᵢ^{g}*=k_{L}^{g}+(k_{S}^{g}−k_{L}^{g})φᵢ=(1−φᵢ)k_{L}^{g}+φᵢk_{S}^{g}, for i=0,1, . . . ,(n−1), (27)

bᵢ^{g}*=b_{L}^{g}+(b_{S}^{g}−b_{L}^{g})φᵢ=(1−φᵢ)b_{L}^{g}+φᵢb_{S}^{g}, for i=0,1, . . . ,(n−1), (28)

bᵢ^{a}*=b_{L}^{a}+(b_{S}^{a}−b_{L}^{a})φᵢ=(1−φᵢ)b_{L}^{a}+φᵢb_{S}^{a}, for i=0,1, . . . ,(n−1), (29)

λᵢ^{g}*=λ_{L}^{g}+(λ_{S}^{g}−λ_{L}^{g})φᵢ=(1−φᵢ)λ_{L}^{g}+φᵢλ_{S}^{g}, for i=0,1, . . . ,(n−1), (30)

λᵢ^{a}*=λ_{L}^{a}+(λ_{S}^{a}−λ_{L}^{a})φᵢ=(1−+φᵢ)λ_{L}^{a}+φᵢλ_{S}^{a}, for i=0,1, . . . ,(n−1), (31)

where (k_{L}^{g}, k_{S}^{g}), (b_{L}^{g}, b_{S}^{g}), (b_{L}^{a}, b_{S}^{a}), (λ_{L}^{g}, λ_{S}^{g}), and (λ_{L}^{a}, λ_{S}^{a}), are liquid and solid “virtual” material properties, respectively, and are assumed to be constants that can be learned from data. The asterisk (*) means uncorrected parameters. All of the above parameters may be corrected by multiplying them by the vertex membership class χᵢ∈{0,1} to zero out the effects on interior particles, and by the ground contact class ηᵢ∈{0,1} or (1−ηᵢ)∈{1,0} to select ground or air effects:

kᵢ^{g}==kᵢ^{g}*ηᵢ, for i−0,1, . . . ,(n−1), (32)

bᵢ^{g}=bᵢ^{g}*ηᵢ, for i−0,1, . . . ,(n−1), (33)

bᵢ^{a}==bᵢ^{a}*ηᵢ, for i−0,1, . . . ,(n−1), (34)

λᵢ^{g}==λᵢ^{g}*ηᵢ, for i−0,1, . . . ,(n−1), (35)

λᵢ^{a}==λᵢ^{a}*ηᵢ, for i−0,1, . . . ,(n−1), (36)

Phase Change: The following constitutive equation is an example equation that captures phase change (i.e., solidification). More specifically, the rate at which phase change occurs, which can be captured at every particle by the following lumped re-interpretation of the Lee model:

ψᵢ=ReLU(R_{S}(T_{L}−Tᵢ)(1−φᵢ))−ReLU(R_{L}(Tᵢ−T_{S})φᵢ), for i=0,1, . . . ,(n−1), (37)

where (R_{L}, R_{S}) are melting and freezing rates and (T_{L}, T_{S}) are melting and freezing temperatures, which produce two competing effects.

Resultant Effects: Now that all pairwise forces and fluxes, as well as external forces and fluxes (source terms and boundary conditions) for both mechanical and thermal effects are accounted for, the total effects on the nodes can be computed. For mechanical modeling, the resultant force on all particles needs to be computed. For every particle represented by a vertex vᵢ∈V, the resultant force is sum of pairwise forces coming from its incident edges and the external forces:

[Fᵢ]=[δ_{i,j}][f̅ⱼ]+[Fᵢ^{ext}],i.e., Fᵢ=Σⱼ₌₀^{m-1}δ_{i,j}f̅ⱼ+Fᵢ^{ext}, for i=0,1, . . . ,(n−1) (38)

where f̅ⱼ=f̅ⱼ^{e}+f̅ⱼ^{c}+f̅ⱼ^{v} is the sum of pairwise forces, including stiffness (internal and boundary) and damping forces, on a given edge eⱼ=(vᵢ, v′)∈E or eⱼ=(v′,vᵢ)∈E defined earlier. [δ_{i,j}]=[δ_{j,i}^{T}] is the transpose of incidence matrix. Its left action on the pairwise forces is another co-boundary operation that superimposes the pairwise forces on all the incident edges to the vertex vᵢ∈V, with the proper ± signs depending on the edge directions. The result is summed with Fᵢ^{ext}=fᵢ^{ge}+fᵢ^{gv}+fᵢ^{ad} that captures the ground stiffness, ground damping, and air drag forces on the particle.

For thermal modeling, the net heat flux into all particles needs to be computed. For every particle represented by a vertex vᵢ∈V, the net heat flux is sum of pairwise heat fluxes coming from its incident edges and the external heat flux:

[Qᵢ]=[δ_{i,j}][q̅ⱼ]+[Qᵢ^{ext}], i.e., Qᵢ=Σⱼ₌₀^{m-1}δ_{i,j}qⱼ+Qᵢ^{ext}, for i=0,1, . . . ,(n−1) (39)

where q̅ⱼ is the exchanged heat along on a given edge eⱼ=(vᵢ, v′)∈E or eⱼ=(v′,vᵢ)∈E defined earlier. [δ_{i,j}]=[δ_{j,i}^{T}] is the transpose of incidence matrix. Its left action on the pairwise heat fluxes is another co-boundary operation that superimposes the pairwise heat fluxes on all the incident edges to the vertex vᵢ∈V, with the proper ± signs depending on the edge directions. The result is summed with Qᵢ^{ext}=qᵢ^{g}+qᵢ^{a} that captures the ground conduction and air convection heat fluxes on the particle.

Balance Equations: For mechanical modeling, the balance equation comes from Newton's law (i.e., the total force on every particle determines its acceleration), thus the velocity can be updated as follows:

$${v}_{i} ( t + Δ t ) = {v}_{i} ( t ) + {\int }_{t}^{t + Δ t} \frac{1}{{m}_{i}} {F}_{i} ( {t}^{′} ) {dt}^{′} \approx {v}_{i} ( t ) + \frac{1}{{m}_{i}} {F}_{i} ( t ) Δ t \qquad ( 40 )$$

If uniform mass distribution among particles is assumed, then mᵢ=1 without loss of generality, because non-dimensionalized equations can be used in which stiffness and damping coefficients are normalized by mass, resulting in parameterization by natural frequencies and damping factors. This leads to fewer degrees of freedom for learning.

Once the velocity is updated, the position can be updated accordingly:

$${x}_{i} ( t + Δ t ) = {x}_{i} ( t ) + {\int }_{t}^{t + Δ t} {v}_{i} ( {t}^{′} ) {dt}^{′} \approx {x}_{i} ( t ) + \frac{{v}_{i} ( t ) + {v}_{i} ( t + Δ t )}{2} Δ t \qquad ( 41 )$$

For thermal modeling, the balance equation comes from Fourier's law (i.e., the net heat flux into every particle determines its rate of change of temperature), thus the temperature can be updated as follows:

$${T}_{i} ( t + Δ t ) = {T}_{i} ( t ) + {\int }_{t}^{t + Δ t} \frac{1}{{C}_{i}} {Q}_{i} ( {t}^{′} ) {dt}^{′} \approx {T}_{i} ( t ) + \frac{1}{{C}_{i}} {Q}_{i} ( t ) Δ t \qquad ( 42 )$$

If uniform heat capacity distribution among particles is assumed, then Cᵢ=1 without loss of generality, because non-dimensionalized equations can be used in which conduction and convection coefficients are normalized by heat capacity. This leads to fewer degrees of freedom for learning.

For phase change, the following similar integral can be used to capture solidification:

$${φ}_{i} ( t + Δ t ) = {φ}_{i} ( t ) + {\int }_{t}^{t + Δ t} \frac{1}{{C}_{i}} {ψ}_{i} ( {t}^{′} ) {dt}^{′} \approx {φ}_{i} ( t ) + \frac{1}{{C}_{i}} {ψ}_{i} ( t ) Δ t \qquad ( 43 )$$

Forward Algorithm: Here is how the simulation may work: Start from initial conditions (i.e., vertex positions [xᵢ(0)], vertex velocities [vᵢ(0)], vertex temperatures [Tᵢ(0)], and vertex phase fractions [φᵢ(0)], for all particles at t=0. Euler integration may be used for time-stepping with a constant Δt>0. At every time step t>0:
(a) Use the current positions [xᵢ(t)] to compute the triangulation (e.g., α-complexes) which determines the edge membership classes [γᵢ(0)] and edge densities [ρᵢ(0)]. Note that the incidence and interpolation matrices need not change.
(b) Compute the next time step's physical variables from the current time step's physical variables:
   Inputs: vertex positions [xᵢ(t)], vertex velocities [vᵢ(t)], vertex temperatures [Tᵢ(t)], vertex phase fractions [φᵢ(t)], vertex membership classes [χᵢ(t)], edge membership classes [γᵢ(t)], and edge densities [ρᵢ(t)].
   Outputs: vertex positions [xᵢ(t+ΔT)], vertex velocities [vᵢ(t+Δt)], vertex temperatures [Tᵢ(t+Δt)], vertex phase fractions [φᵢ(t+Δt)], and modified edge densities [ρᵢ(t+Δt)].
(c) Iterate (repeat the above two steps) for as many time steps as needed.

The step (b) is the physical co-simulation of coupled mechanical, thermal, and phase change equations, that proceeds as follows:
1. Map vertex variables [xᵢ(t)], [vᵢ(t)], [Tᵢ(t)], and [φᵢ(t)] to edge variables [xⱼ(t)], [vⱼ(t)], [Tⱼ(t)], and [φⱼ(t)] via equations given above in Differencing and Interpolationg.
2. Modify the edge density based on proximity via equation (7).
3. Compute pairwise effects [f̅ⱼ^{e}(t)], [f̅ⱼ^{c}(t)], [f̅ⱼ^{v}(t)], and [q̅ⱼ(t)] via equations given above in Constitutive Equations.
4. Compute external effects [fᵢ^{ge}(t)], [fᵢ^{gv}(t)], [fᵢ^{ad}(t)], [qᵢ^{g}(t)], and [qᵢ^{a}(t)] via equations given above in External Effects.
5. Compute rate of phase change [ψᵢ(t)] via equation (37).
6. Map pairwise effects from edges to vertices and add them up with external effects on vertices to obtain [Fᵢ(t)] and [Qᵢ(t)] as prescribed above in Resultant Effects.
7. Use Euler integration to obtain [xᵢ(t+Δt)], [vᵢ(t+Δt)], [Tᵢ(t+Δt)], and [φᵢ(t+Δt)], as prescribed above in Balance Equations.

Inversion: Learning: The step (b) can be viewed as a map parameterized by the following 26 parameters: (α^{cut}, L^{cut}), (k_{L}, k_{S}), (c_{L}, c_{S}), (b_{L}, b_{S}), (λ_{L}, λ_{S}), (L_{L}^{eq}, L_{S}^{eq}), (k_{L}^{g}, k_{S}^{g}), (b_{L}^{g}, b_{S}^{g}), (b_{L}^{a}, b_{S}^{a}), (λ_{L}^{g}, λ_{S}^{g}), (λ_{L}^{a}, λ_{S}^{a}), (R_{L}, R_{S}), and (T_{L}, T_{S}), used to define linear interpolations for various constitutive equations that depend on proximity and phase. These parameters can be trained by machine learning if the inputs and outputs of this map are given, generated by a PDE solver (e.g., OpenFOAM).

As such, the forward algorithm model can be implemented as a recurrent neural network in PyTorch and trained by back propagation.

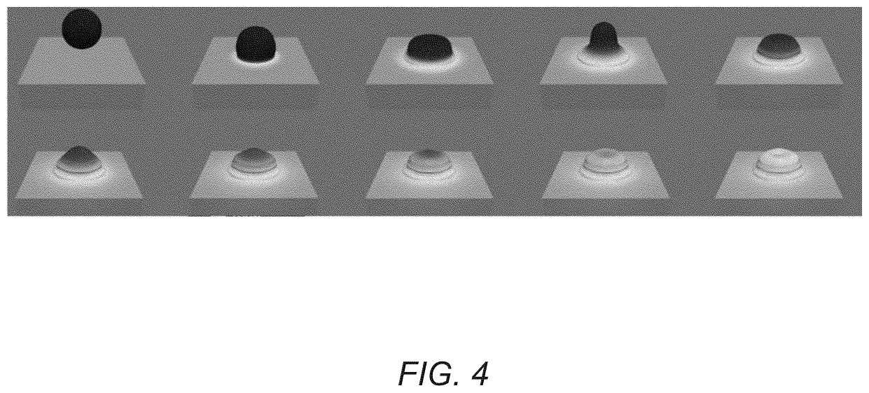

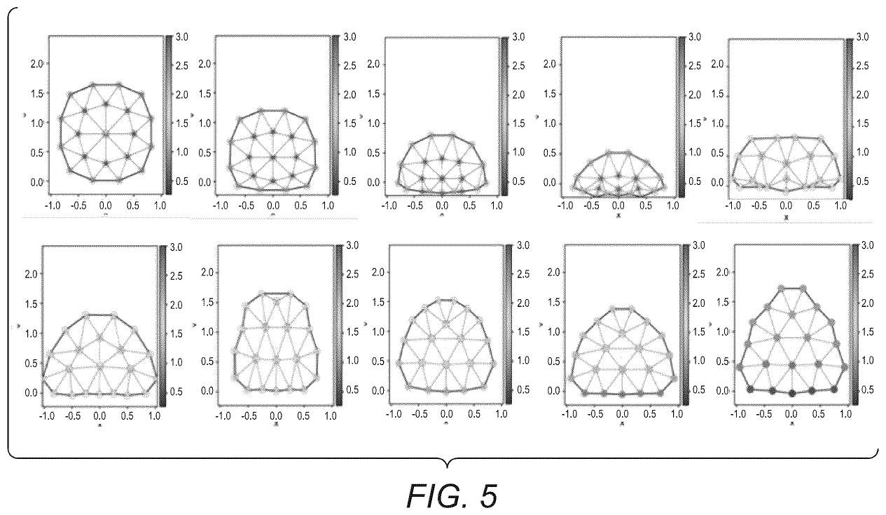

FIG. 4 illustrates several frames of a high-fidelity model for additive manufacturing that, in this instances, shows a temperature map (400° C. to 1100° C., light to dark) of a solidifying droplet cooling on a substrate. FIG. 5 illustrates similarly a droplet falling, impact, solidification, and coalescence (specifically for liquid metal jet additive manufacturing) but, in contrast to FIG. 4, is for a lumped parameter model where the gradation indicates temperature and the size indicates phase fraction (solid to liquid ratio) for each lumped super-particle.

### Example Embodiments

Clause 1. A method comprising: describing governing equations of an additive manufacturing process; refactoring the governing equations into (1) constitutive laws with unknown coefficients and (2) conservation laws; discretizing the governing equations; and training the unknown coefficients of the constitutive laws with simulated data and/or experimental data relating to the additive manufacturing process where the conservation laws are enforced in the training regardless of a granularity of the constitutive laws, thereby yielding a reduced-order set of governing equations.

Clause 2. The method of claim 1, further comprising implementing of the reduced-order set of governing equations using neural networks.

Clause 3. The method of Clause 2, wherein the training of the unknown coefficients uses tensor-based computations for spatial operators and/or temporal operators.

Clause 4. The method of Clause 2 or Clause 3, wherein the neural network is a recurrent neural network for temporal integration.

Clause 5. The method of any of Clauses 1-4, wherein the governing equations are one or more of: ordinary or partial differential equations, differential-algebraic equations, integral equations, or integro-differential equations.

Clause 6. The method of any of Clauses 1-5, wherein the discretizing of the governing equations comprises using one or more of: a finite difference scheme, a finite volume scheme, a finite element scheme, a spectral scheme, or a mimetic scheme.

Clause 7. The method of any of Clauses 1-6, wherein the training of the constitutive laws comprises assuming an algebraic form for the constitutive laws with the unknown coefficients and fitting the unknown coefficients to the simulated data and/or the experimental data.

Clause 8. The method of Clause 7, wherein the unknown coefficients parameterize material properties including one or more of: elasticity, viscosity, conductivity, heat capacity, surface tension, solidification parameters, or any combination thereof.

Clause 9. The method of any of Clauses 1-8, wherein the constitutive laws comprise one or more of: a single-physics constitutive relation and a multi-physics coupling interaction.

Clause 10. The method of any of Clauses 1-9, wherein the constitutive laws comprise a relationship between one or more physical quantities related to the additive manufacturing process measured at one or more of: at points, along curve segments, over surface areas, or within volumes of finite length scale.

Clause 11. The method of Clause 10, wherein the one or more physical quantities comprise flow velocity and pressure, temperature, stress, strain, strain rate, heat flux, heat content, force, displacement, phase, or any combination thereof.

Clause 12. The method of Clause 10 or Clause 11, wherein the one or more physical quantities are correlated with an additive manufacturing operation parameter that include one or more of: temperature, pressure, laser power, scan rate, or material deposition rate.

Clause 13. The method of any of Clauses 1-12, wherein the additive manufacturing process is one of: material extrusion, powder bed fusion, material jetting, binder jetting, or directed energy deposition.

Clause 14. The method of any of Clauses 1-13, wherein the method further comprises: simulating the additive manufacturing process for a part using the reduced-order set of governing equations.

Clause 15. The system of Clause 14 further comprising: performing the additive manufacturing process to produce the part using parameters derived during the simulating of the additive manufacturing process for the part.

Clause 16. A system comprising: a computing system comprising: a processor; a memory coupled to the processor; and instructions provided to the memory, wherein the instructions are executable by the processor to cause the system to perform a method comprising: describing governing equations of an additive manufacturing process; refactoring the governing equations into (1) constitutive laws with unknown coefficients and (2) conservation laws; discretizing the governing equations; and training the unknown coefficients of the constitutive laws with simulated data and/or experimental data relating to the additive manufacturing process where the conservation laws are enforced in the training regardless of a granularity of the constitutive laws, thereby yielding a reduced-order set of governing equations.

Clause 17. The system of Clause 16, wherein the method further comprises: simulating the additive manufacturing process for a part using the reduced-order set of governing equations.

Clause 18. The system of Clause 17 further comprising: an additive manufacturing apparatus coupled to the computing system; and wherein the method further comprises sending instructions to the additive manufacturing machine from the processor regarding parameters for performing the additive manufacturing process for producing the part.

Clause 19. The system of Clause 18, wherein the parameters include one or more of: temperature, pressure, laser power, scan rate, or material deposition rate.

Clause 20. The method of any of Clauses 16-19, wherein the additive manufacturing process is one of: material extrusion, powder bed fusion, material jetting, binder jetting, or directed energy deposition.

Clause 21. A method comprising: describing an additive manufacturing process with symbolic partial differential equations (PDEs); refactoring the symbolic PDEs into (1) constitutive laws with unknown coefficients and (2) conservation laws; training the unknown coefficients of the constitutive laws with simulated data and/or experimental data relating to the additive manufacturing process where the conservation laws are enforced regardless of a granularity of each of the constitutive laws, thereby yielding trained governing equations comprise ordinary differential equations (ODEs) for the additive manufacturing process; and implementing the trained governing equations in a neural network to yield a reduced-order multi-physics model of the additive manufacturing process.

Clause 22. The method of Clause 21, wherein the symbolic PDEs are scale-agnostic.

Clause 23. The method of any of Clauses 21-22, wherein the refactoring of the symbolic PDEs comprises discretizing the conservation laws.

Clause 24. The method of Clause 23, wherein the discretizing of the conservation laws comprises discretizing a central difference scheme, finite volume scheme, or mimetic scheme.

Clause 25. The method of any of Clauses 21-24, wherein the refactoring of the symbolic PDEs comprises symbolically semi-discretizing the constitutive laws into the ODEs with the unknown coefficients, and wherein the training of the constitutive laws comprises deriving the unknown coefficients.

Clause 26. The method of any of Clauses 21-25, wherein the constitutive laws comprise a single-physics constitutive relation and/or a multi-physics coupling interaction.

Clause 27. The method of any of Clauses 21-26, wherein the constitutive laws comprise a relationship between one or more properties of a material in the additive manufacturing process as a function of one or more parameters of the additive manufacturing process.

Clause 28. The method of Clause 27, wherein the one or more properties of the material comprises elasticity, viscosity, conductivity, heat capacity, phase, or any combination thereof.

Clause 29. The method of any of Clauses 27-28, wherein the one or more parameters of the additive manufacturing process comprises temperature, pressure, laser power, scan rate, material deposition rate, or any combination thereof.

Clause 30. The method of any of Clauses 21-29, wherein the training of the unknown coefficients uses a first tensor-based computation for spatial operators and a second tensor-based computation for temporal operators.

Clause 31. The method of Clause 30, wherein the training of the unknown coefficients uses a feed-forward neural network.

Clause 32. The method of Clause 31, wherein the neural network is a recurrent neural network.

Clause 33. The method of any one of Clauses 21-32, wherein the training of the unknown coefficients uses temporal integration solving for initial values and boundary values using a recurrent neural network.

Clause 34. The method of Clause 33, wherein the neural network is the recurrent neural network.

Clause 35. The method of any of Clauses 21-34, wherein the additive manufacturing process is one of: material extrusion, powder bed fusion, material jetting, binder jetting, or directed energy deposition.

Clause 36. A computing system comprising: a processor; a memory coupled to the processor; and instructions provided to the memory, wherein the instructions are executable by the processor to cause the system to perform the method of any of Clauses 21-35.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

Therefore, the present invention is well adapted to attain the ends and advantages mentioned as well as those that are inherent therein. The particular examples and configurations disclosed above are illustrative only, as the present invention may be modified and practiced in different, but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method comprising:
describing governing equations of an additive manufacturing process;
refactoring the governing equations into (1) constitutive laws with unknown coefficients and (2) conservation laws;
discretizing the governing equations; and
training the unknown coefficients of the constitutive laws with simulated data and/or experimental data relating to the additive manufacturing process where the conservation laws are enforced in the training regardless of a granularity of the constitutive laws, thereby yielding a reduced-order set of governing equations.

2. The method of claim 1, further comprising implementing of the reduced-order set of governing equations using neural networks.

3. The method of claim 2, wherein the training of the unknown coefficients uses tensor-based computations for spatial operators and/or temporal operators.

4. The method of claim 2, wherein the neural network is a recurrent neural network for temporal integration.

5. The method of claim 1, wherein the governing equations are one or more of: ordinary or partial differential equations, differential-algebraic equations, integral equations, or integro-differential equations.

6. The method of claim 1, wherein the discretizing of the governing equations comprises using one or more of: a finite difference scheme, a finite volume scheme, a finite element scheme, a spectral scheme, or a mimetic scheme.

7. The method of claim 1, wherein the training of the constitutive laws comprises assuming an algebraic form for the constitutive laws with the unknown coefficients and fitting the unknown coefficients to the simulated data and/or the experimental data.

8. The method of claim 7, wherein the unknown coefficients parameterize material properties including one or more of: elasticity, viscosity, conductivity, heat capacity, surface tension, solidification parameters, or any combination thereof.

9. The method of claim 1, wherein the constitutive laws comprise one or more of: a single-physics constitutive relation and a multi-physics coupling interaction.

10. The method of claim 1, wherein the constitutive laws comprise a relationship between one or more physical quantities related to the additive manufacturing process measured at one or more of: at points, along curve segments, over surface areas, or within volumes of finite length scale.

11. The method of claim 10, wherein the one or more physical quantities comprise flow velocity and pressure, temperature, stress, strain, strain rate, heat flux, heat content, force, displacement, phase, or any combination thereof.

12. The method of claim 10, wherein the one or more physical quantities are correlated with an additive manufacturing operation parameter that include one or more of: temperature, pressure, laser power, scan rate, or material deposition rate.

13. The method of claim 1, wherein the additive manufacturing process is one of: material extrusion, powder bed fusion, material jetting, binder jetting, or directed energy deposition.

14. The method of claim 1, wherein the method further comprises:
simulating the additive manufacturing process for a part using the reduced-order set of governing equations.

15. The system of claim 14 further comprising:
performing the additive manufacturing process to produce the part using parameters derived during the simulating of the additive manufacturing process for the part.

16. A system comprising:
a computing system comprising:
a processor;
a memory coupled to the processor; and
instructions provided to the memory, wherein the instructions are executable by the processor to cause the system to perform a method comprising:
describing governing equations of an additive manufacturing process;
refactoring the governing equations into (1) constitutive laws with unknown coefficients and (2) conservation laws;
discretizing the governing equations; and
training the unknown coefficients of the constitutive laws with simulated data and/or experimental data relating to the additive manufacturing process where the conservation laws are enforced in the training regardless of a granularity of the constitutive laws, thereby yielding a reduced-order set of governing equations.

17. The system of claim 16, wherein the method further comprises:
simulating the additive manufacturing process for a part using the reduced-order set of governing equations.

18. The system of claim 17 further comprising:
an additive manufacturing apparatus coupled to the computing system; and
wherein the method further comprises sending instructions to the additive manufacturing machine from the processor regarding parameters for performing the additive manufacturing process for producing the part.

19. The system of claim 18, wherein the parameters include one or more of: temperature, pressure, laser power, scan rate, or material deposition rate.

20. The method of claim 16, wherein the additive manufacturing process is one of: material extrusion, powder bed fusion, material jetting, binder jetting, or directed energy deposition.
